(19) United States
(12) Patent Application Publication
(10) Pub. No.: US 2010/0106781 A1
(43) Pub. Date: Apr. 29, 2010

(54) AUTOMATIC UPDATE OF CONTACT INFORMATION IN MESSAGING

(75) Inventor: Prakash Gupta, Allahabad (IN)

Correspondence Address: MOTOROLA, INC., 1303 EAST ALGONQUIN ROAD, IL01/3RD, SCHAUMBURG, IL, 60196, US

(73) Assignee: SYMBOL TECHNOLOGIES, INC., Holtsville, NY (US)

(21) Appl. No.: 12/257,805

(22) Filed: Oct. 24, 2008

(51) Int. Cl. H04W 4/12; G06F 15/16

(52) U.S. Cl. 709/206; 455/466

(57) ABSTRACT

Methods and systems for automatically updating contact information or executing other commands via a messaging system can automatically associate a command tag with a message. The command tag can, for example, have a value indicating that the message contains contact information, or have another value corresponding to a command. Based on the value of the command tag, the message receiving component can automatically extract the contact information and apply it to a contact database, or can execute the command.

### TECHNICAL FIELD

The subject disclosure relates generally to messaging, and more particularly to methods and systems for automatically updating contact information in a contact list in a messaging system, for example an email system or short message service system.

### BACKGROUND

Contact lists in messaging systems are known. For example, an email application can enable a user to maintain a list of family, friends and business associates, along with their contact information, such as email addresses, phone numbers, residential addresses and the like. Short message service (SMS) or “texting” applications can provide a similar capability. A contact list enables a user to quickly and conveniently look up and contact a listed person or organization, without the delay and possible expense, for example, of reference to a directory service.

Naturally, contact information changes from time to time, making it necessary to update a contact list accordingly. An update may be disseminated, for example, by a user who has a change in his contact information and needs to convey the change to those on his contact list. Conventional techniques for updating a contact list can entail inefficiencies and undue effort. For example, one way of propagating updates is to do so manually. That is, a user might simply email or otherwise send a message containing the update information to everyone on his contact list, individually and one at a time. However, especially for a long contact list, this approach could be laborious and error-prone. Moreover, the sender could not be sure that the receiver was noticing and applying the updated information

In view of the above, automated techniques for updating contact information have been developed. However, conventional automated techniques suffer disadvantages. For example, one known technique requires subscribing to a service that uses a server to poll contacts on a contact list to request update information. This approach, in addition to incurring the cost of the subscription, has the further drawback that recipients on the contact list may be unresponsive, for example because they are too busy or distracted by other matters.

In consideration of the foregoing, innovation in automatically updating contact information is called for.

### SUMMARY

The following presents a simplified summary of the subject innovation in order to provide a basic understanding of some aspects described herein. This summary is not an extensive overview of the disclosed subject matter. It is intended to neither identify key or critical elements of the disclosed subject matter nor delineate the scope of the subject innovation. Its sole purpose is to present some concepts of the disclosed subject matter in a simplified form as a prelude to the more detailed description that is presented later.

According to aspects of the subject innovation, methods and systems for automatically updating contact information in a messaging system can automatically associate an indicator with a message, to indicate that the message contains contact information. The indicator can be automatically detected by a message receiving component. Based on detecting the indicator, the message receiving component can automatically extract the contact information and apply it to a contact database, such as a contact list or “address book.”

In embodiments, the indicator can be a command tag that is associated with the message. For example, the command tag can be appended to a message body. The command tag can have a value assigned to it to indicate that the message contains contact information. The message receiving component can detect the command tag and determine its value. If the value of the command tag indicates that the message contains contact information, the message receiving component can extract the contact information from the message. The message receiving component can apply the extracted contact information to the contact information database to update the contact information database.

According to further aspects of the subject innovation, a message composing component can receive user commands, data and the like, and interactively display information and perform other operations relating to a messaging application. For example, the message composing component can receive an input from a user specifying that a message to be sent is a “Contact Update” type of message. Based on receiving the input, the message composing component can prompt the user for contact information, and set the value of the command tag indicate that the message contains contact information. The message composing component can send the message including the contact information and the command tag to the message receiving component.

The message receiving component can receive and process the message. In processing the message, the message receiving component can detect the command tag and determine its value. The message receiving component can receive user commands, data and the like, and interactively display information and perform other operations relating to a messaging application. For example, if the message receiving component determines that the command tag indicates that the message includes contact information, the message receiving component can extract the contact information and display it to a user. The message receiving component can further prompt the user to indicate whether or not to accept the message, based, for example, on whether or not the user recognizes and/or trusts the message sender.

Additionally or alternatively, the message receiving component can automatically process the message without user intervention. For example, the message receiving component can apply a validation test to the message, to determine whether to apply the contact information to the contact database. For example, the message receiving component can compare an identifier of a message sender to entries on a contact list. If the identifier matches an entry on the contact list, the message receiving component can accept the message and apply the contact information to the contact database. Otherwise, the message receiving component can reject or discard the message.

According to still further aspects of the subject innovation, the command tag can be multi-valued and multi-purposed. For example, a first value of the command tag can indicate that the message contains contact information and is to be processed as described above. A second or other value of the command tag can indicate that the message contains one or more commands, additionally or alternatively to contact information, to be performed by the message receiving component.

To the accomplishment of the foregoing and related ends, the innovation, then, comprises the features hereinafter fully described and particularly pointed out in the claims. The following description and the annexed drawings set forth in detail certain illustrative embodiments of the innovation. These embodiments can be indicative, however, of but a few of the various ways in which the principles of the innovation can be employed. Other objects, advantages, and novel features of the innovation will become apparent from the following detailed description of the innovation when considered in conjunction with the drawings.

### BRIEF DESCRIPTION OF THE DRAWINGS

Various non-limiting embodiments are further described with reference to the accompanying drawings in which:

FIG. 1 shows a system including a message composing component and a message receiving component in accordance with aspects of the subject matter disclosed herein;

FIG. 2 shows components of a message in accordance with aspects of the subject matter disclosed herein;

FIG. 3 shows the message receiving component processing a message in accordance with aspects of the subject matter disclosed herein;

FIG. 4 shows further details of the message receiving component processing a message in accordance with aspects of the subject matter disclosed herein;

FIG. 5 shows details of the message composing component in accordance with aspects of the subject matter disclosed herein;

FIG. 6 shows further details of the message composing component, including operations of a user interface component thereof, in accordance with aspects of the subject matter disclosed herein;

FIG. 7 shows details of the message receiving component in accordance with aspects of the subject matter disclosed herein;

FIG. 8 shows further details of the message receiving component, including operations of a user interface component thereof, in accordance with aspects of the subject matter disclosed herein;

FIG. 9 shows a methodology for composing a message in accordance with aspects of the disclosed subject matter;

FIG. 10 shows further operations for composing a message in accordance with aspects of the disclosed subject matter;

FIG. 11 shows a methodology including operations associated with a message receiving component in accordance with aspects of the disclosed subject matter;

FIG. 12 shows further operations associated with a message receiving component in accordance with aspects of the subject matter disclosed herein;

FIG. 13 shows another methodology for composing a message in accordance with aspects of the disclosed subject matter;

FIG. 14 shows further operations for composing a message in accordance with aspects of the disclosed subject matter;

FIG. 15 shows further operations associated with a message receiving component in accordance with aspects of the subject matter disclosed herein;

FIGS. 16 and 17 show examples of implementations of systems in accordance with aspects of the subject matter disclosed herein; and

FIG. 18 shows an example of an operating environment that can be employed in accordance with aspects of the disclosed subject matter.

### DETAILED DESCRIPTION

As utilized in this application, the terms “component,” “system,” “interface,” and the like are intended to refer to a computer-related entity, either hardware, software (e.g., in execution), and/or firmware. For example, a component can be a process running on a processor, a processor, an object, an executable, a program, and/or a computer. By way of illustration, both an application running on a server and the server can be a component. One or more components can reside within a process and a component can be localized on one computer and/or distributed between two or more computers.

The subject innovation is described with reference to the drawings, wherein like reference numerals are used to refer to like elements throughout. In the following description, for purposes of explanation, numerous specific details are set forth in order to provide a thorough understanding of the subject innovation. It may be evident, however, that the subject innovation may be practiced without these specific details. In other instances, well-known structures and devices are shown in block diagram form in order to facilitate describing the subject innovation.

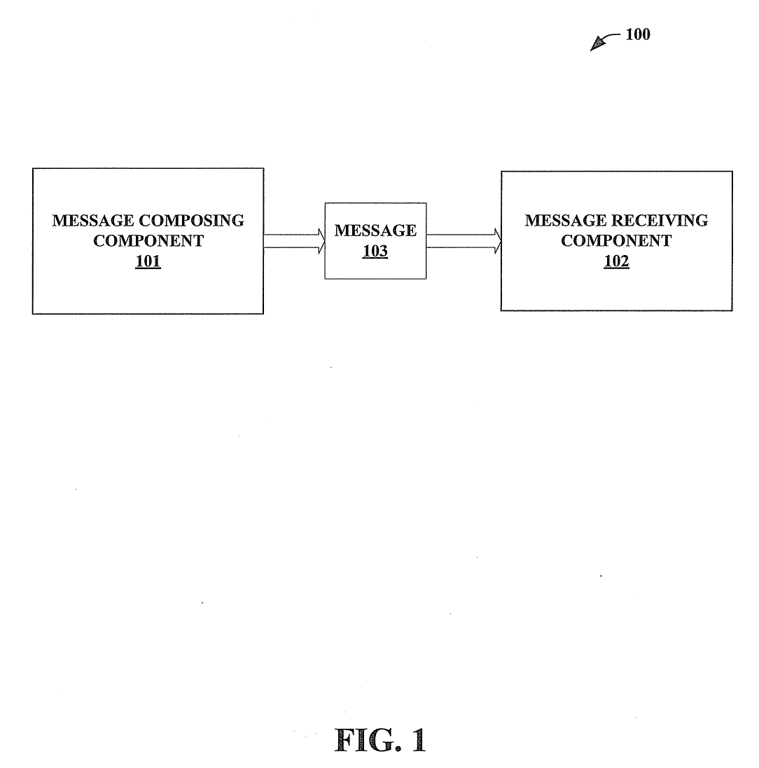

Referring now to FIG. 1, a system 100 according to embodiments of the subject innovation can include a message composing component 101 and a message receiving component 102. The message composing component 101 can create and send a message 103 to the message receiving component 102.

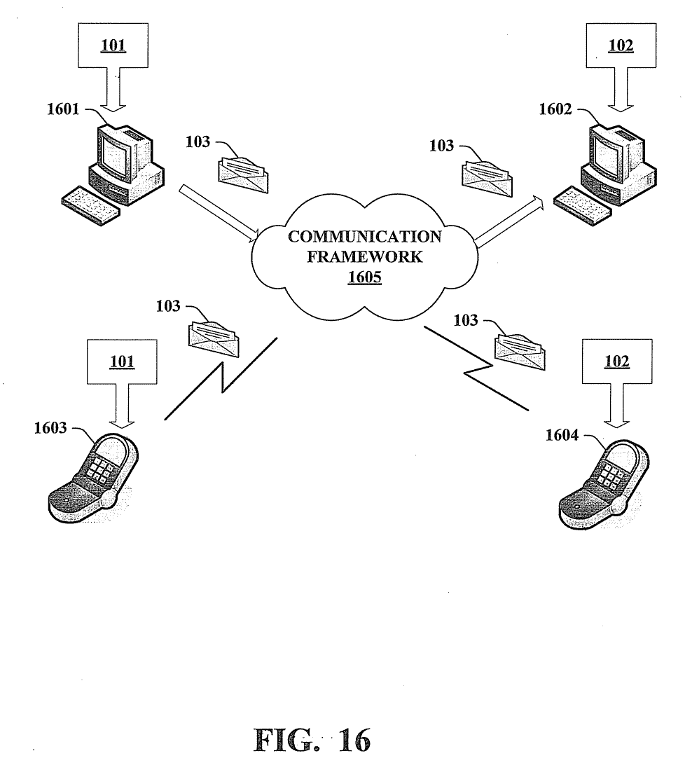

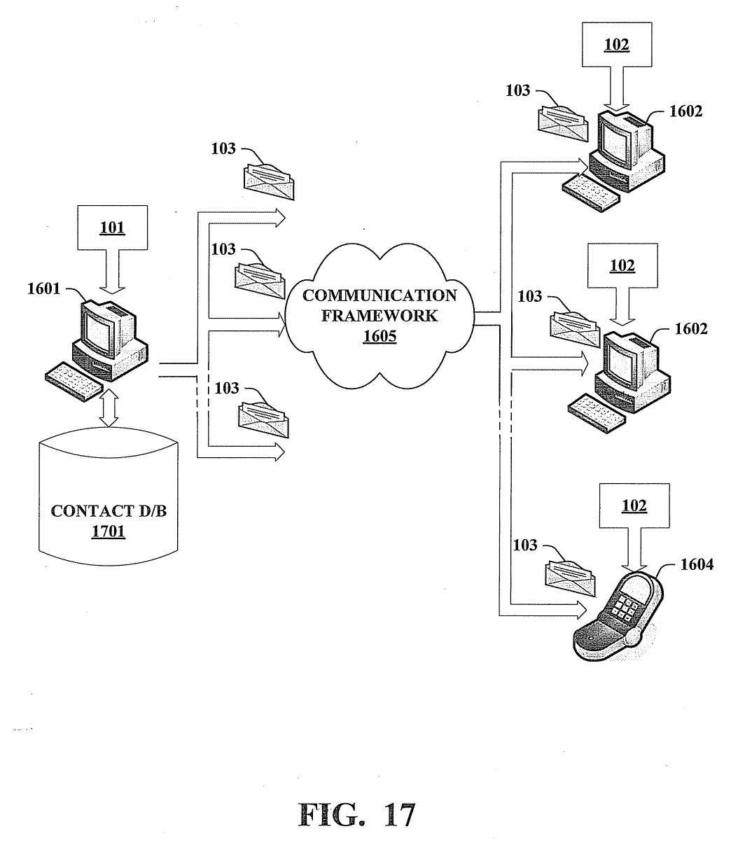

Typically, the sending message composing component 101 is physically separate from the receiving message receiving component 102. For example, in an illustrative embodiment, discussed in more detail further on with reference to FIGS. 16 and 17, the sending message composing component 101 is a component of a communication and computing device, such as a personal computer or a cell phone, that can communicate with the receiving message receiving component 102 via a communication framework such as a network. The receiving message receiving component 102 can likewise be a component of a communication and computing device, such as a personal computer or a cell phone, physically separate from the sending communication and computing device. The message 103 can be transmitted via the communication framework between the two physically separate communication and computing devices respectively configured with the sending message composing component 101 and the receiving message receiving component 102.

It should further be appreciated, as additionally illustrated and described further on with reference to FIGS. 16 and 17, that a communication and computing device can include both a message composing component 101 and a message receiving component 102. The message composing component 101 can create and send a message to a message receiving component 102 on a separate device, and the message receiving component 102 can receive a message from a separate device. Moreover, a message composing component 101 can create and send a message to each of a plurality of message receiving components 102 included in respective separate devices, as described in more detail further on.

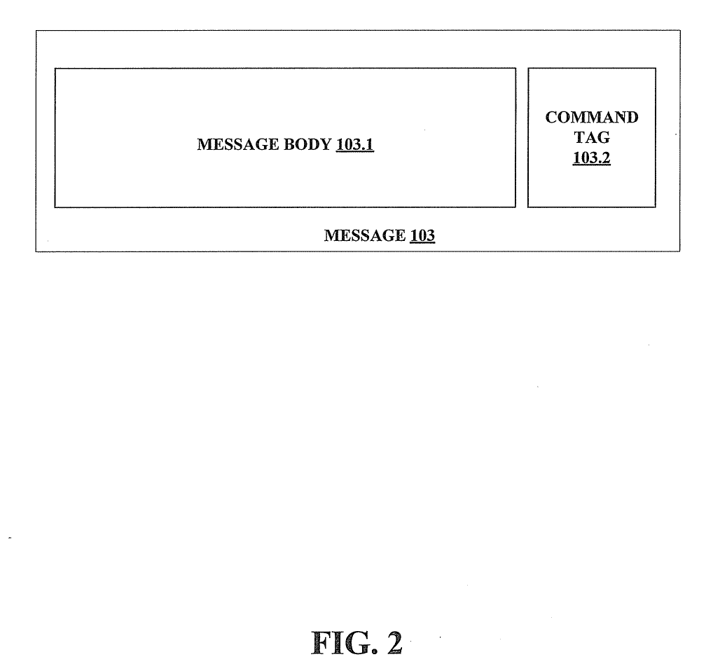

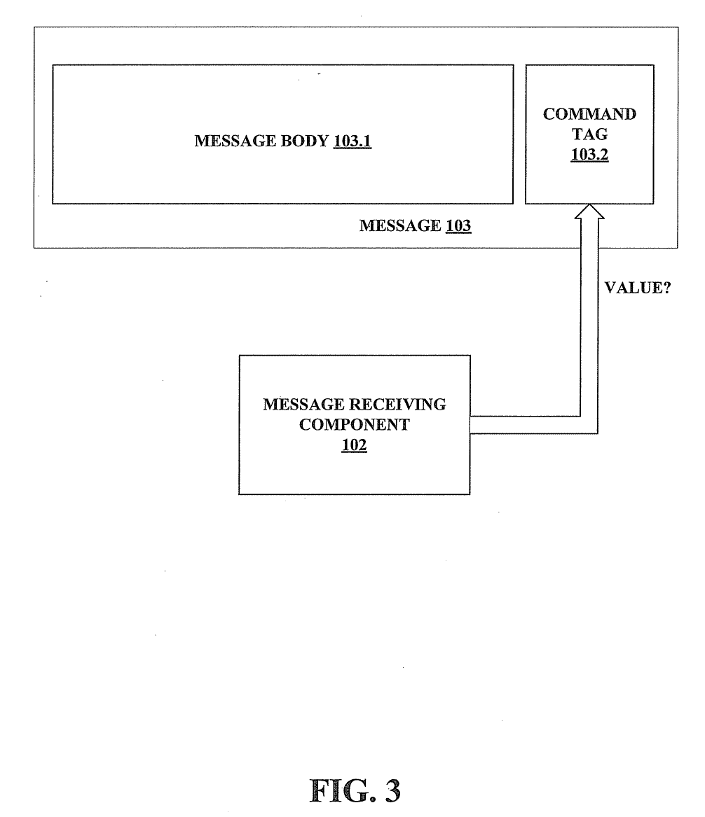

As shown in FIG. 2, the message 103 can include a message body 103.1 and a command tag 103.2. As shown in FIG. 3, the message receiving component 102 can read, analyze, parse or otherwise process the message 103. In particular, the message receiving component 102 can detect the presence of the command tag 103.2, and can further determine a value assigned to the command tag 103.2. The value assigned to the command tag 103.2 can indicate whether the message 103 includes contact information.

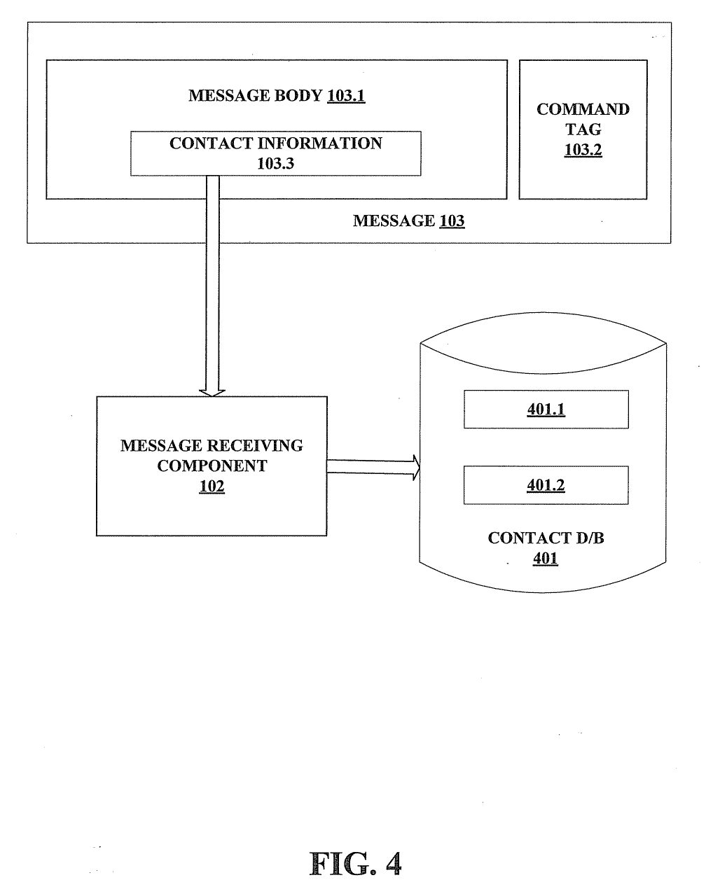

As shown in FIG. 4, if the command tag 103.2 indicates that the message 103 contains contact information 103.3, the message receiving component 102 can extract the contact information 103.3 and store it in a contact database 401. The contact database 401 can be a contact list, for example, such as an email or SMS contact list, “address book” and the like. In storing the contact information 103.3 in the contact database 401, the message receiving component 102 can, for example, create a new record or records 401.1, or update an old or pre-existing record 401.2.

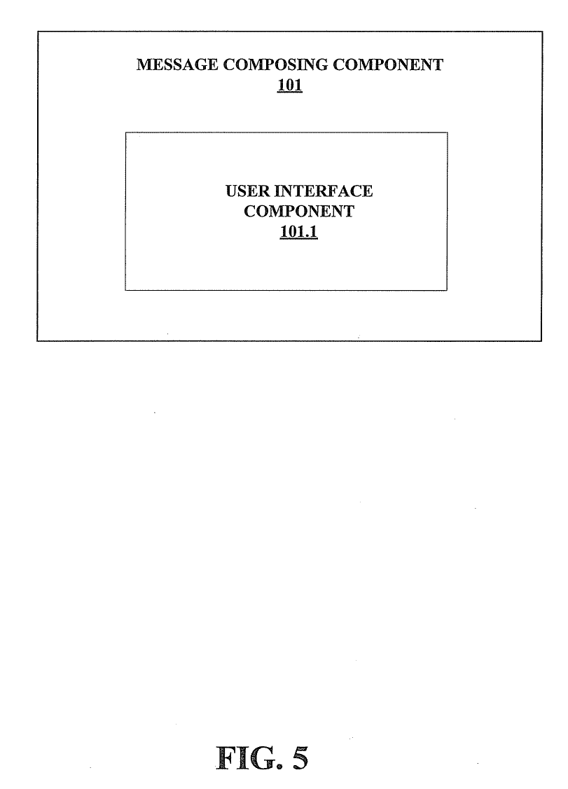

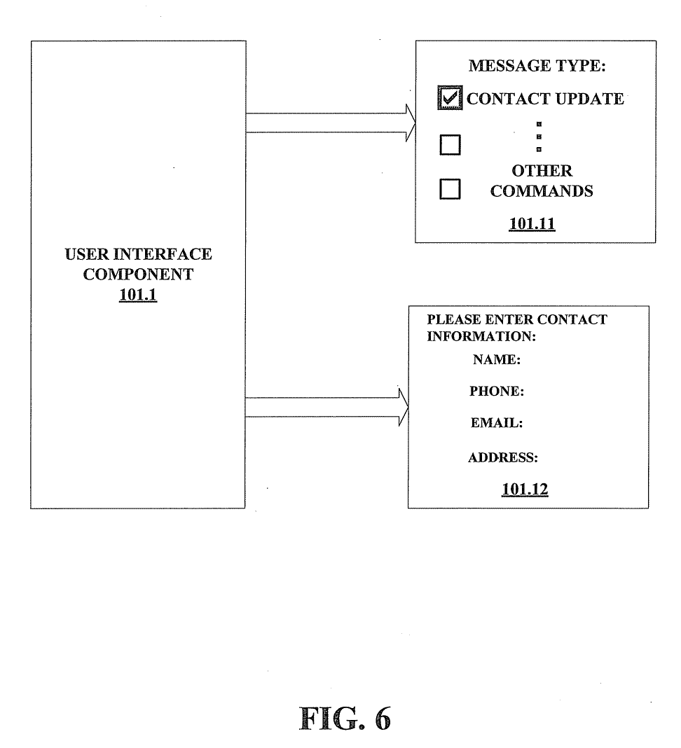

Referring now to FIG. 5, the message composing component 101 can include a user interface component 101.1 to receive user commands, data and the like, and interactively display information and perform other operations relating to a messaging application. As shown in FIG. 6, the user interface component 101.1 can include screen displays, such as displays 101.11 and 101.12. A screen display of the user interface component 101.1 can, for example, present an option for creating a “Contact Update” type of message, for example by selecting the option from a menu or drop-down list or other form of visually presenting multiple selectable options, as shown in display 101.11. If the user selects the “Contact Update” type of message, the user interface component 101.1 can, in response, present a display or displays with prompts and data entry fields or “dialog boxes” for collecting contact information, such as display 101.12. The contact information can include such information, for example, as names, telephone numbers, email addresses, residential addresses, business addresses, websites, URLs (uniform resource locators), or any other kind of information. Additionally, in response to a user selection of the “Contact Update” type of message, the message composing component 101 can automatically set a value of the command tag 103.2 to indicate that the message 103 contains contact information.

The display 101.11 can further include options to select other types of commands, and based on the selection, the message composing component 101 can automatically set a value of the command tag 103.2 to indicate that the message 103 contains the other type of command or commands.

The user can fill in some or all of the requested contact information in the dialog boxes of the user interface component 101.1. The message composing component 101 can then construct a message 103 including the contact information and the command tag 103.2 indicating that the message 103 includes contact information 103.3. The user can then select a “Send” or “Transmit” option, for example (not shown), to send the message 103 to the message receiving component 102.

The command tag 103.2 can, for example, be appended to an end of the message body 103.1, although the subject innovation is not limited with respect to a location or format of the command tag 103.2. Alternatively, the command tag 103.2 can be in a message header or trailer or other part of the message, or can precede or follow the message in a separate message or other form of communication, or an indication that the message contains contact information can be otherwise signaled to the message receiving component 102. The command tag 103.2 can be binary valued; that is, take one of two possible values, such as “1” or “0”, “high” or “low”, or “on” or “off”. For example, a “1”, “high” or “on” value for the command tag 103.2 can indicate that the message 103 includes contact information, while a “0”, “low” or “off” value for the command tag 103.2 can indicate that the message 103 does not contain contact information. However, the command tag 103.2 need not be binary-valued, and could instead, for example, include character data or data in another format. The command tag 103.2 can be configured so that it is not visible, for example, in a screen display of the message 103, while still being detectable and readable by the message receiving component 102.

In embodiments, the command tag 103.2 can be multi-valued, e.g., have more than two values, and act as a multi-purpose command tag. For example, a first value assigned the command tag 103.2, such as “1” or “CU” can indicate that the message 103 is a “Contact Update” type of message as described above, and that the message receiving component 102 should process the message 103 accordingly. A second or other value, such as “2” or “Cmd” can indicate that the message should receive different processing. For example, the second value can indicate that the message 103 includes, alternatively or in addition to contact information, a command for the message receiving component 102 to perform some predetermined operation or operations, such as launching a browser or configuring a system locally.

For example, the message body 103.1 can contain a URL, and the command tag value can instruct the receiving component 102 to automatically launch the URL in a browser. Additionally or alternatively, for example, the message body 103.1 can contain one or more time zone settings, and the command tag value can instruct the message receiving component 102 to apply the time zone settings to a local communication and computing device, such as a communication and computing device configured with the message receiving component 102. Further, additionally or alternatively, for example, the message body 103.1 can contain one or more shell commands, and the command tag value can instruct the message receiving component 102 to launch the one or more shell commands.

Based on detecting the second or other value, the message receiving component 103 can, for example, extract the command from the message body 103.1 and execute it or otherwise perform the indicated operation or operations. In embodiments, the command can be encoded into the value of the command tag 103.2, and need not be extracted from the message body 103.1. For example, a value of “2” assigned to the command tag 103.2 can instruct the message receiving component 102 to “perform Operation X,” a value of “3” assigned to the command tag 103.2 can instruct the message receiving component to “perform Operation Y,” and the like.

As described previously, the message receiving component 102 can read, analyze, parse or otherwise process the message 103. In particular, the message receiving component 102 can detect the presence of the command tag 103.2 and determine its value. If the value of the command tag 103.2 indicates that the message 103 contains contact information, the message reading component 102 can extract the contact information from the message 103. For example, the contact information can be in a body 103.1 of the message 103, and the message receiving component 102 can parse the body 103.1 to extract the contact information.

The message receiving component 102 can, for example, be configured to be compatible with the message composing component 101, in such a way that the message receiving component 102 can recognize the message 103 as a “Contact Update” type of message, based on the value assigned to the command tag 103.2, or as a message containing another command of some kind, and process the message 103 accordingly. Additionally or alternatively, the message receiving component 102 can include a generalized functionality enabling it to parse messages of disparate formats to detect and extract contact information and/or one or more commands therein, based on a signal that a message contains contact information and/or one or more commands.

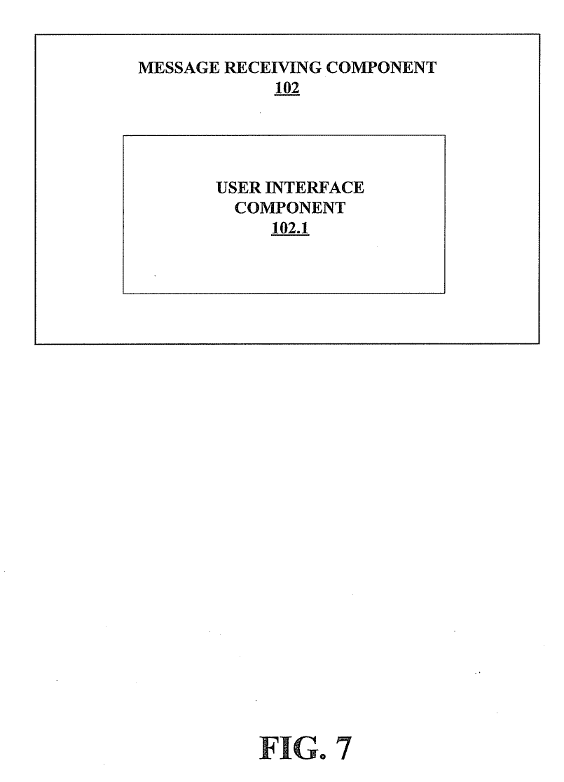

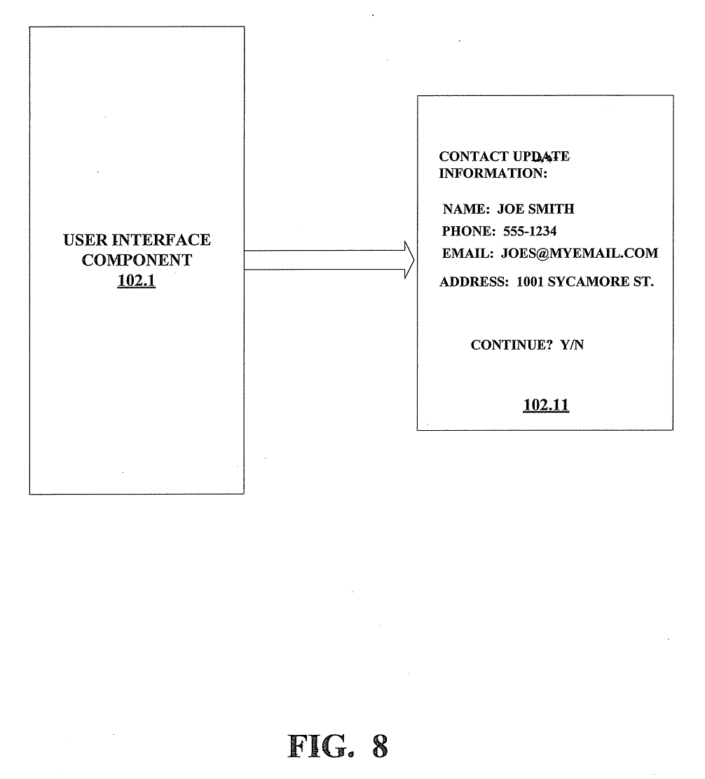

Referring now to FIG. 7, the message receiving component 102 can include a user interface component 102.1 for interacting with a user to receive commands, data and the like, and display information relating to a messaging application. As shown in FIG. 8, the user interface component 102.1 can include one or more screen displays, such as a display 102.11. If the message receiving component 102 is configured to as to be able to recognize a message 103 as a “Contact Update” type of message, the user interface component 102.1 can, for example, display the contact information extracted from the message 103 in a predetermined legible format, as shown in the display 102.11. A similar display can be generated if the command tag 103.2 indicates a different command from a “Contact Update” operation.

Because some message content can be harmful or malicious, the user interface component 102.1 can further apply a validation test to the received message 103, for security purposes, for example. The validation test can, for example, include prompting a recipient for a response to indicate whether to accept the message or not. For example, the display 102.11 can include a prompt such as “CONTINUE? Y/N” as shown. If the recipient replies “Y” (as in “yes, continue to process the message”), the message receiving component 102 can apply the contact information to a contact database such as contact database 401, or execute another command as indicated by the command tag 103.2. On the other hand, if the recipient replies “N” (as in “no, do not continue to process the message”), the message receiving component 102 can reject or discard the message. The recipient user might base his decision on whether to accept or reject the message based, for example, on whether he recognizes and/or trusts the sender.

The validation test need not be explicit or require user intervention as described above. For example, the message 103 can be either accepted or rejected without user intervention, based on predetermined criteria automatically applied by the message receiving component 102. The predetermined criteria can include, for example, whether or not the sender is on a contact list of the recipient. That is, the message receiving component 102 can automatically compare an identifier of a sender of a received message 103 against a list of entries in a contact list, and if the identifier of the sender is on the list, automatically apply the received contact information to the corresponding sender on the contact list. If the sender is not on the list, the message receiving component 102 can reject or discard the message 103.

The criteria can further include, for example, a “trust level.” More specifically, one or more message senders can be each be associated with a specified “trust level.” The one or more message senders can correspond, for example, to contacts in the contact database, and the trust levels can be assigned to respective contacts in the contact database. If the trust level corresponding to the sender of a message is set at or above a given predetermined threshold, the message can be automatically accepted and processed without user intervention. If, on the other hand, the trust level corresponding to the sender of the message is below a given predetermined threshold, the message can be rejected or discarded, or the user can be prompted to indicate whether to accept the message.

The trust level can be adjustable by a user. For example, the trust level can be graphically represented by the user interface component 102.1 as a sliding-scale or graduated setting or control, capable of being manipulated by an input device such as a keyboard or mouse to designate or adjust the trust level. Further, artificial intelligence based systems (e.g., explicitly and/or implicitly trained classifiers) can be employed in connection with performing inference and/or probabilistic determinations and/or statistical-based determinations regarding whether or not to accept a message, as described in more detail further on.

As described above, the message receiving component 102 can be I configured to recognize a “Contact Update” message generated by a message component 101 and process it accordingly. However, some (e.g., legacy) applications on a receiving side of a messaging system may not have the functionality to recognize a command tag 103.2 in a message. Accordingly, the message composing component 101 can be configured so that a “Contact Update” message that it creates is readable/parseable by conventional message receiving applications, so that contact information in the message can be legibly displayed by a receiving application in a conventional manner.

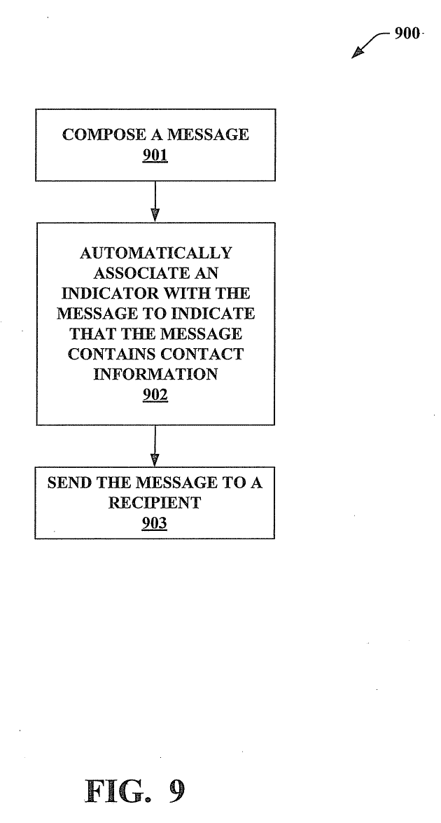

FIGS. 9-15 illustrate methodologies and/or flow charts in accordance with the subject innovation. For simplicity of explanation, the methodologies are depicted and described as a series of acts. It is to be understood and appreciated that the subject innovation is not limited by the acts illustrated and/or by the order of acts, for example acts can occur in various orders and/or concurrently, and with other acts not presented and described herein. Furthermore, not all illustrated acts may be required to implement the methodologies in accordance with the disclosed subject matter. In addition, those skilled in the art will understand and appreciate that the methodologies could alternatively be represented as a series of interrelated states by way of a state diagram or events. Additionally, it should be further appreciated that the methodologies disclosed hereinafter and throughout this specification are capable of being stored on an article of manufacture to facilitate transporting and transferring such methodologies to computers. The term article of manufacture, as used herein, is intended to encompass a computer program accessible from any machine-readable device, carrier, or media.

Referring now to FIG. 9, illustrated is a methodology 900 in accordance with aspects of the subject matter disclosed herein. As shown in block 901, a message composing component can compose (e.g., create, generate) a message. The message composing component can automatically include an indicator in or with or otherwise associated with the message, to indicate that the message contains contact information, as shown in block 902. In embodiments, the indicator can be a command tag or field as described above, appended to a message body, for example, or otherwise associated with the message. As shown in block 903, the message composing component can send the message to a recipient.

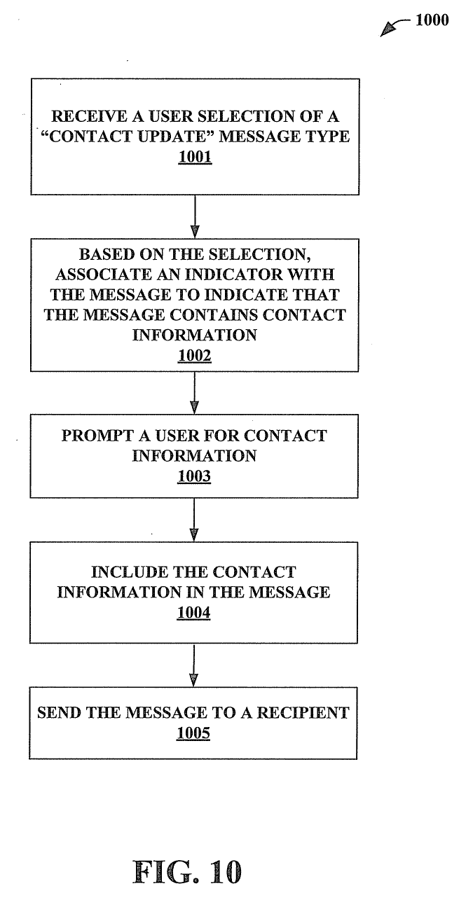

Referring to FIG. 10, a methodology 1000 in accordance with further aspects of the subject matter disclosed herein is shown. As part of operations to compose a message as described above with reference to blocks 901 and 902, a message composing component can receive a user selection of a “Contact Update” message type, as shown in block 1001. Based on the selection, the message composing component can automatically associate an indicator with the message to indicate that the message contains contact information, as shown in block 1002. As shown in block 1003, the message composing component can prompt the user, for example by way of a user interface component that presents dialog boxes to the user, to enter contact information. As shown in block 1004, the message composing component can include the contact information in a message, for example in a body of the message. As shown in block 1005, the message composing component can send the message to a recipient.

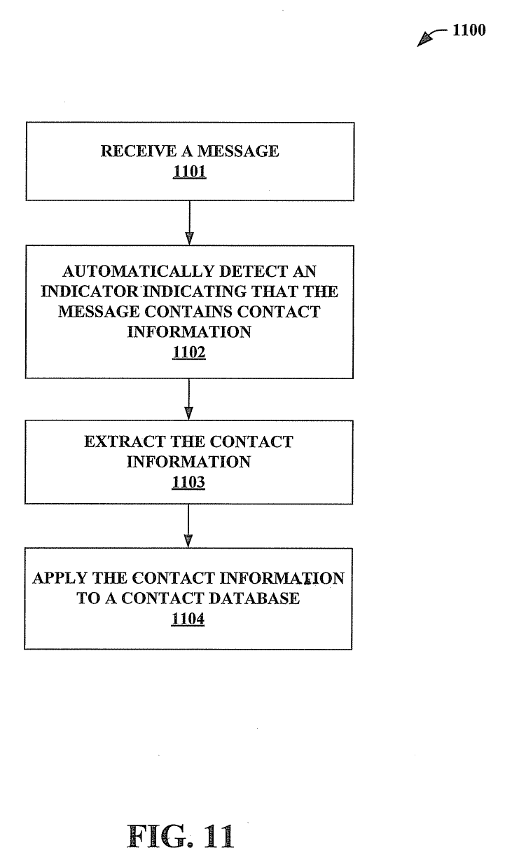

Referring to FIG. 11, a methodology 1100 in accordance with still further aspects of the subject matter disclosed herein is shown. As shown in block 1101, a message receiving component can receive a message. The message receiving component can automatically detect an indicator associated with the message, indicating that the message contains contact information, as shown in block 1102. For example, the indicator can be a command tag appended to an end of a message body, as described above. As shown in block 1103, the message receiving component can extract the contact information from the message, and apply the contact information to a contact database, as shown in block 1104. The contact database can be a contact list, address book, and the like, in a messaging application, as described above.

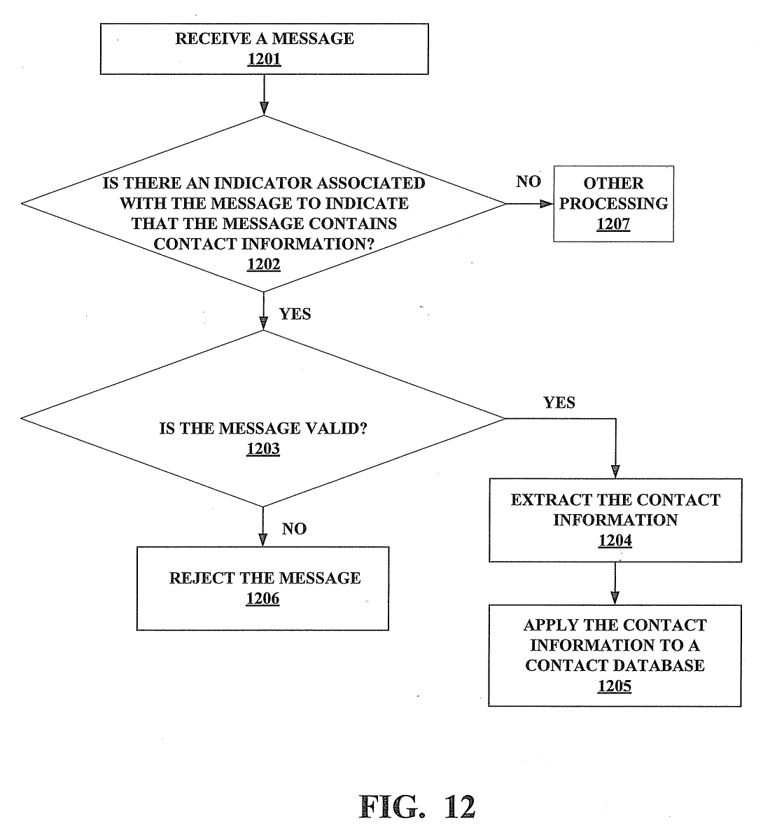

Referring to FIG. 12, a methodology 1200 in accordance with still further aspects of the subject matter disclosed herein is shown. As shown in block 1201, a message receiving component can receive a message. The message receiving component can determine whether there is an indicator associated with the message to indicate that the message contains contact information, as shown in block 1202. For example, the indicator can be a command tag as described above. As shown in block 1203, a validation test can be applied to the message. The validation test can include, for example, checking a sender of the message against a contact list, or applying a “trust level” criterion, and the like, as described above.

If the validation test is passed (“YES” branch of block 1203), the message receiving component can extract the contact information, as shown in block 1204, and apply the contact information to a contact database, as shown in block 1205. If the validation test is not passed (“NO” branch of block 1203), the message receiving component can reject the message, as shown in block 1206.

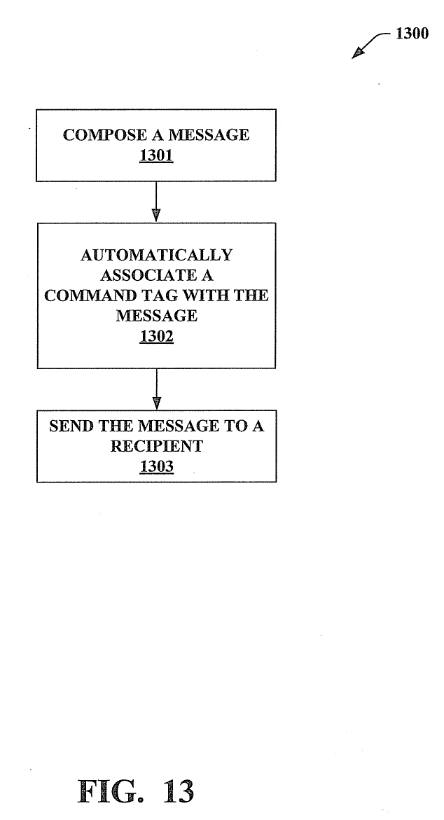

Referring to FIG. 13, illustrated is a methodology 1300 in accordance with still further aspects of the subject matter disclosed herein. As shown in block 1301, a message composing component can compose (e.g., create, generate) a message. The message composing component can automatically include a command tag in or with, or otherwise associate the command tag with, the message, as shown in block 1302. The command tag can be assigned one of a plurality of values. A value assigned to the command tag can instruct a recipient to execute one or more commands. Executing a command can include performing one or more operations. For example, a first value assigned to the command tag can instruct a message receiving component to perform “Contact Update” operations as described above. A second or other value assigned to the command tag can instruct the message receiving component to perform one or more other operations. As shown in block 1303, the message composing component can send the message to a recipient.

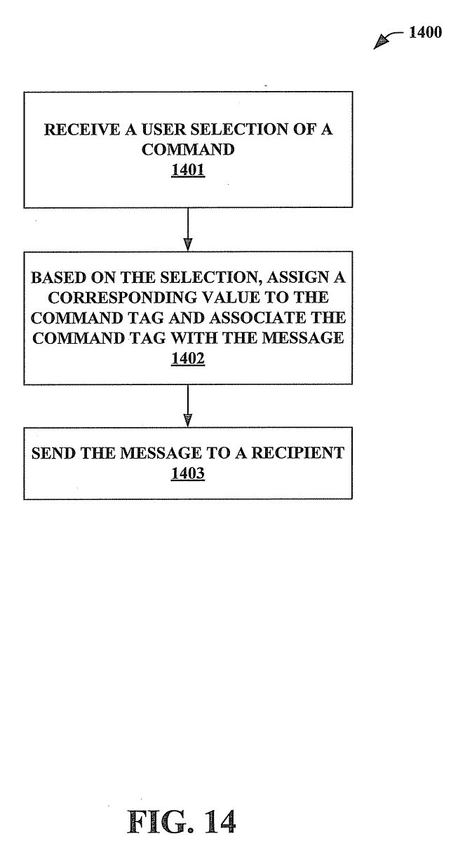

Referring to FIG. 14, a methodology 1400 in accordance with still further aspects of the subject matter disclosed herein is shown. As part of operations to compose a message as described above with reference to blocks 1301 and 1302, a message composing component can receive a user selection of a command, as shown in block 1401. Based on the selection, the message composing component can assign a corresponding value to a command tag, and automatically associate the command tag with the message, as shown in block 1402. As shown in block 1403, the message composing component can send the message to a recipient.

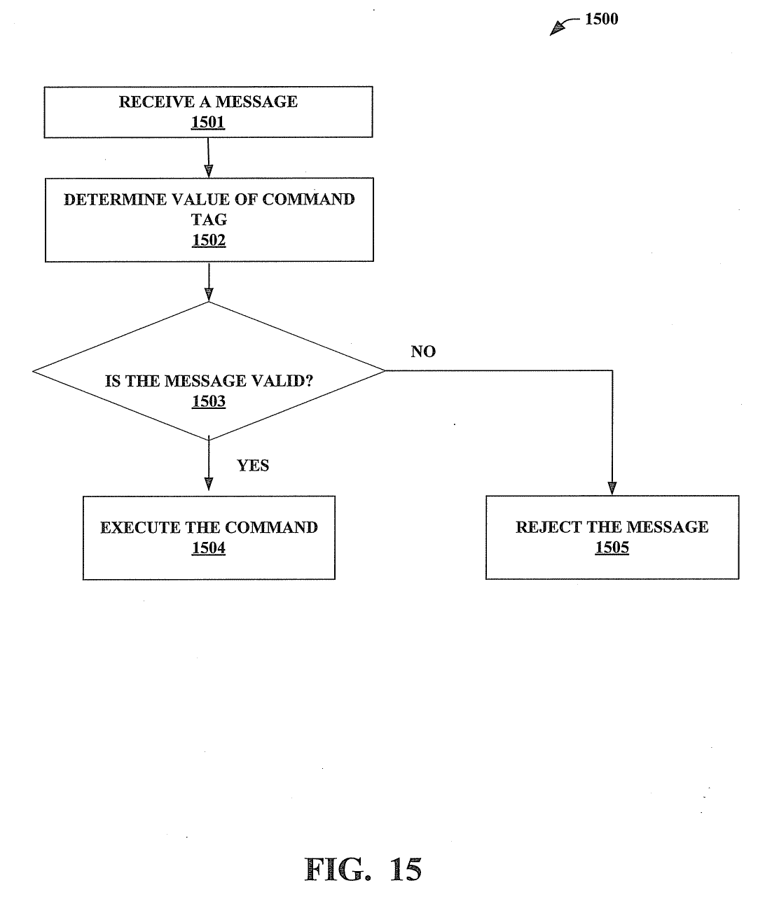

Referring to FIG. 15, a methodology 1500 in accordance with still further aspects of the subject matter disclosed herein is shown. As shown in block 1501, a message receiving component can receive a message. The message receiving component can determine the value of a command tag associated with the message, as shown in block 1502. As shown in block 1503, a validation test can be applied to the message. The validation test can include, for example, checking a sender of the message against a contact list, or applying a “trust level” criterion, and the like, as described above.

If the validation test is passed (“YES” branch of block 1503), the message receiving component can execute a command corresponding to the value of the command tag, as shown in block 1504. If the validation test is not passed (“NO” branch of block 1503), the message receiving component can reject the message, as shown in block 1505.

FIG. 16 shows an example of a communication and computing environment in which embodiments of the subject innovation can find useful application. In FIG. 16, communication and computing devices 1601, 1602, 1603 and 1604 communicate via a communication framework 1605. Devices 1601 and 1602 represent communication and computing devices such as personal computers or other kinds of computers in a home, business, organization and the like. Devices 1603 and 1604 represent mobile devices such as cell phones and personal digital assistants (PDAs).

A sending device, such as device 1601 or 1603, can be configured with a message composing component 101 as described above. The sending communication device 1601 or 1603 can compose a message 103 according to any or all of the methodologies described above, and transmit the message 103 via the communication framework 1605 a receiving device 1602 or 1604. The receiving device 1602 or 1604 can be configured with a message receiving component 102 as described above. The receiving device 1602 or 1604 can receive the message 103 and process the message according to any or all of the methodologies described above. Of course, each of the communication and computing devices 1601, 1602, 1603 and 1604 can be configured with both the message composing component 101 and the message receiving component 102, and thus both create, send, receive and process messages in accordance with the above. The message composing component 101 and message receiving component 102 can include or be a component of or interface with an email application and or SMS application, and the message 103 can be an email message or an SMS message, for example. The communication framework 1605 can comprise wired and wireless channels and networks, including, for example, the Internet or World-Wide Web, an SMS, a second generation (2G) Global System for Mobile Communications (GSM) network, a code division multiple access (CDMA) network, or a third generation (3G) mobile network.

In more detail, the communication framework 1605 can support wired network connections (e.g., daisy chains, system busses, intranets, wide area networks (WANs), local area networks (LANs), . . . ), wireless network connections (e.g., daisy chains, system busses, intranets, wide area networks (WANs), local area networks (LANs), . . . ), or combinations thereof, for communicatively coupling devices 1301-1304.

Referring to FIG. 17, a sending communication and computing device 1601 configured with a message composing component 101 can include or communicate with a contact database 1701. For example, the contact database 1701 can be a contact list of contacts to whom a user of the communication and computing 1601wants to send updated contact information. The message composing component 101 can create a message 103 and send the message to one or more of the contacts on the contact list 1701. For example, the message composing component 101 can, substantially at the same time, send the message 103 to all the contacts on the contact list 1701. Of course, the sending communication and computing device can also be a mobile device 1603, and the receiving communication and computing devices can all be mobile devices such as device 1604, or all communication and computing devices such as personal computers or other kinds of computers in a home, business, organization and the like, such as devices 1602, or a combination as shown in FIG. 17.

Receiving communication and computing devices 1602 and 1604 can each correspond to a contact on the contact list 1701. The receiving communication and computing devices 1602 and 1604 can each be configured with a message receiving component 102, and can receive and process the message 103 in accordance with the foregoing description. Thus, in one illustrative application, both a sending user and a receiving user can conveniently and with little effort synchronize contact information.

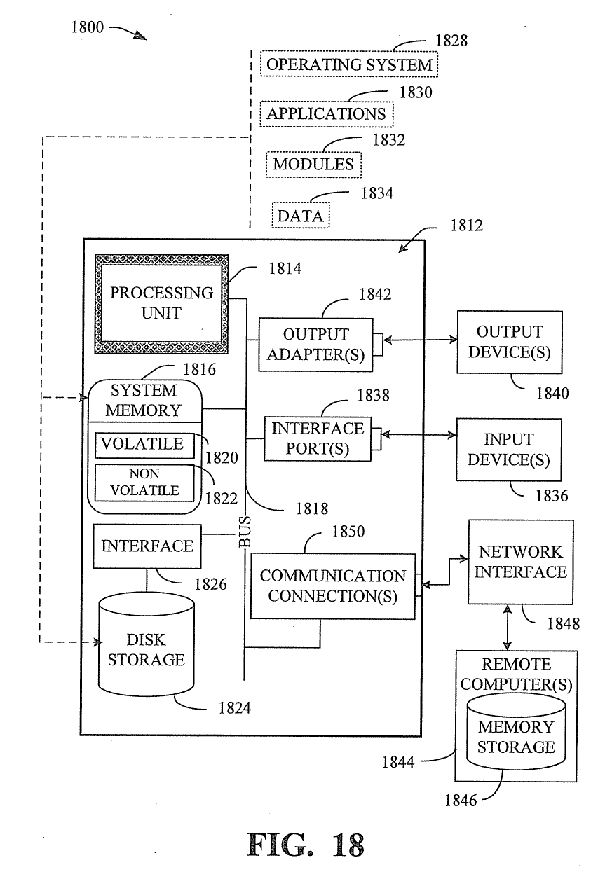

With reference to FIG. 18, an example of an environment 1800 for implementing various aspects of the subject innovation can include a computer 1812. The computer 1812 can include a processing unit 1814, a system memory 1816, and a system bus 1818. The system bus 1818 can couple system components including, but not limited to, the system memory 1816 to the processing unit 1814. The processing unit 1814 can be any of various available processors. Dual microprocessors and other multiprocessor architectures also can be employed as the processing unit 1814.

The system bus 1818 can be any of several types of bus structure(s) including the memory bus or memory controller, a peripheral bus or external bus, and/or a local bus using any variety of available bus architectures including, but not limited to, Industrial Standard Architecture (ISA), Micro-Channel Architecture (MSA), Extended ISA (EISA), Intelligent Drive Electronics (IDE), VESA Local Bus (VLB), Peripheral Component Interconnect (PCI), Card Bus, Universal Serial Bus (USB), Advanced Graphics Port (AGP), Personal Computer Memory Card International Association bus (PCMCIA), Firewire (IEEE 1494), and Small Computer Systems Interface (SCSI).

The system memory 1816 can include volatile memory 1820 and nonvolatile memory 1822. The basic input/output system (BIOS), containing basic routines to transfer information between elements within the computer 1812, such as during start-up, can be stored in nonvolatile memory 1822. By way of illustration, and not limitation, nonvolatile memory 1822 can include read only memory (ROM), programmable ROM (PROM), electrically programmable ROM (EPROM), electrically erasable programmable ROM (EEPROM), or flash memory. Volatile memory 1820 can include random access memory (RAM), which can act as external cache memory. By way of illustration and not limitation, RAM is available in many forms such as static RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), Rambus direct RAM (RDRAM), direct Rambus dynamic RAM (DRDRAM), and Rambus dynamic RAM (RDRAM).

Computer 1812 can also include removable/non-removable, volatile/non-volatile computer storage media. FIG. 18 illustrates, for example, a disk storage 1824. Disk storage 1824 can include, but is not limited to, devices like a magnetic disk drive, floppy disk drive, tape drive, Jaz drive, Zip drive, LS-100 drive, flash memory card, or memory stick. In addition, disk storage 1824 can include storage media separately or in combination with other storage media including, but not limited to, an optical disk drive such as a compact disk ROM device (CD-ROM), CD recordable drive (CD-R Drive), CD rewritable drive (CD-RW Drive) or a digital versatile disk ROM drive (DVD-ROM). To facilitate connection of the disk storage devices 1824 to the system bus 1818, a removable or non-removable interface is typically used such as interface 1826.

It is to be appreciated that FIG. 18 describes software that can act as an intermediary between users and the basic computer resources described in the suitable operating environment 1800. Such software can include an operating system 1828. Operating system 1828, which can be stored on disk storage 1824, can act to control and allocate resources of the computer system 1812. System applications 1830 can take advantage of the management of resources by operating system 1828 through program modules 1832 and program data 1834 stored, for example, either in system memory 1816 or on disk storage 1824. It is to be appreciated that embodiments of the subject innovation can be implemented with various operating systems or combinations of operating systems.

A user can enter commands or information into the computer 1812 through input device(s) 1836. Input devices 1836 can include, but are not limited to, a pointing device such as a mouse, trackball, stylus, touch pad, keyboard, microphone, joystick, game pad, satellite dish, scanner, TV tuner card, digital camera, digital video camera, web camera, and the like. These and other input devices can connect to the processing unit 1814 through the system bus 1818 via interface port(s) 1838. Interface port(s) 1838 can include, for example, a serial port, a parallel port, a game port, and a universal serial bus (USB). Output device(s) 1840 can use some of the same type of ports as input device(s) 1836. Thus, for example, a USB port may be used to provide input to computer 1812, and to output information from computer 1812 to an output device 1840. Output adapter 1842 can be provided to illustrate that there are some output devices 1840 like monitors, speakers, and printers, among other output devices 1840, which require special adapters. The output adapters 1842 can include, by way of illustration and not limitation, video and sound cards that provide a means of connection between the output device 1840 and the system bus 1818. It should be noted that other devices and/or systems of devices can provide both input and output capabilities such as remote computer(s) 1844.

Computer 1812 can operate in a networked environment using logical connections to one or more remote computers, such as remote computer(s) 1844. The remote computer(s) 1844 can be a personal computer, a server, a router, a network PC, a workstation, a microprocessor based appliance, a peer device or other common network node and the like, and typically includes many or all of the elements described relative to computer 1812. For purposes of brevity, only a memory storage device 1846 is illustrated with remote computer(s) 1844. Remote computer(s) 1844 can be logically connected to computer 1812 through a network interface 1848 and then physically connected via communication connection 1850. Network interface 1848 can encompass wire and/or wireless communication networks such as local-area networks (LAN) and wide-area networks (WAN). LAN technologies include Fiber Distributed Data Interface (FDDI), Copper Distributed Data Interface (CDDI), Ethernet, Token Ring and the like. WAN technologies include, but are not limited to, point-to-point links, circuit switching networks like Integrated Services Digital Networks (ISDN) and variations thereon, packet switching networks, and Digital Subscriber Lines (DSL).

Communication connection(s) 1850 refers to the hardware/software employed to connect the network interface 1848 to the bus 1818. While communication connection 1850 is shown for illustrative clarity inside computer 1812, it can also be external to computer 1812. The hardware/software necessary for connection to the network interface 1848 includes, for exemplary purposes only, internal and external technologies such as, modems including regular telephone grade modems, cable modems and DSL modems, ISDN adapters, and Ethernet cards.

As noted above, artificial intelligence based systems (e.g., explicitly and/or implicitly trained classifiers) can be employed in connection with performing inference and/or probabilistic determinations and/or statistical-based determinations as in accordance with one or more aspects of the disclosed subject matter as described herein. As used herein, the term “inference,” “infer” or variations in form thereof refers generally to the process of reasoning about or inferring states of the system, environment, and/or user from a set of observations as captured through events and/or data. Inference can be employed to identify a specific context or action, or can generate a probability distribution over states, for example. The inference can be probabilistic—that is, the computation of a probability distribution over states of interest based on a consideration of data and events. Inference can also refer to techniques employed for composing higher-level events from a set of events and/or data. Such inference results in the construction of new events or actions from a set of observed events and/or stored event data, whether or not the events are correlated in close temporal proximity, and whether the events and data come from one or several event and data sources. Various classification schemes and/or systems (e.g., support vector machines, neural networks, expert systems, Bayesian belief networks, fuzzy logic, data fusion engines . . . ) can be employed in connection with performing automatic and/or inferred action in connection with the disclosed subject matter.

In particular and in regard to the various functions performed by the above described components, devices, circuits, systems and the like, the terms (including a reference to a “means”) used to describe such components are intended to correspond, unless otherwise indicated, to any component which performs the specified function of the described component (e.g., a functional equivalent), even though not structurally equivalent to the disclosed structure, which performs the function in the herein illustrated exemplary aspects of the innovation. In this regard, it will also be recognized that the innovation includes a system as well as a machine-readable (e.g., computer-readable) medium having computer-executable instructions for performing the acts and/or events of the various methods of the innovation.

In addition, while a particular feature of the innovation may have been disclosed with respect to only one of several implementations, such feature may be combined with one or more other features of the other implementations as may be desired and advantageous for any given or particular application. Furthermore, to the extent that the terms “includes,” and “including” and variants thereof are used in either the detailed description or the claims, these terms are intended to be inclusive in a manner similar to the term “comprising.”

What has been described above includes examples of aspects of the disclosed subject matter. It is, of course, not possible to describe every conceivable combination of components or methodologies for purposes of describing the disclosed subject matter, but one of ordinary skill in the art will recognize that many further combinations and permutations of the disclosed subject matter are possible. Accordingly, the disclosed subject matter is intended to embrace all such alterations, modifications and variations that fall within the spirit and scope of the appended claims.

What is claimed is:

1. A method for automatically updating contact information in a messaging system, comprising:
creating a message; and
automatically associating an indicator with the message to indicate that the message contains contact information;
wherein, based on the indicator, a receiving component automatically applies the contact information to a contact database.

2. The method of claim 1, further comprising prompting a user to provide the contact information.

3. The method of claim 2, wherein the prompting includes presenting a display including fields for entry of the contact information.

4. The method of claim 2, further comprising including the contact information in a body of the message.

5. The method of claim 1, further comprising sending the message to a recipient.

6. A machine-readable medium tangibly embodying instructions for performing the method of claim 1.

7. A method for automatically updating contact information in a messaging system, comprising:
receiving a message;
detecting an indicator associated with the message, the indicator indicating that the message contains contact information; and
based on the detecting, automatically applying the contact information to a contact database.

8. The method of claim 7, further comprising parsing a body of the message to extract the contact information.

9. The method of claim 7, further comprising applying a validation test to the message.

10. The method of claim 9, wherein the validation test comprises prompting a user to indicate whether to accept the message.

11. The method of claim 9, wherein the validation test comprises applying a trust-level criterion to a sender of the message.

12. A machine-readable medium tangibly embodying instructions for performing the method of claim 7.

13. A system for automatically updating contact information, comprising:
a processor; and
a memory coupled to the processor and storing instructions executable by the processor to generate a command tag in a message, the command tag being detectable by a receiving application and indicating whether the message contains contact information.

14. The system of claim 13, wherein the command tag is binary-valued.

15. A communication device configured with a system according to claim 13.

16. A system for automatically updating contact information, comprising:
a processor; and
a memory coupled to the processor and storing instructions executable by the processor to determine a value of a command tag in a received message, the command tag to indicate whether the message contains contact information.

17. The system of claim 16, the instructions to further, if the command tag indicates that the message contains contact information, extract the contact information and apply it to a contact database.

18. The system of claim 16, wherein the message is an email message.

19. The system of claim 16, wherein the message is a short message service (SMS) message.

20. A communication device configured with a system according to claim 16.

21. A method for sending a command via a messaging system, comprising:
creating a message; and
automatically associating a command tag with the message, wherein a value of the command tag indicates a command to be automatically performed by a receiving component.

22. The method of claim 22, further comprising prompting a user to select the command.

23. The method of claim 21, further comprising sending the message to a recipient.

24. A machine-readable medium tangibly embodying instructions for performing the method of claim 21.

26. A method for automatically executing a command received via a messaging system, comprising:
receiving a message;
determined a value of a command tag associated with the message; and
executing a command corresponding to the value of the command tag.

27. The method of claim 26, further comprising applying a validation test to the message.

28. A machine-readable medium tangibly embodying instructions for performing the method of claim 26.

29. A communication device configured with instructions for performing a method according to claim 21.

30. A communication device configured with instructions for performing a method according to claim 26.
